(19) United States
(12) Patent Application Publication
(10) Pub. No.: US 2025/0094097 A1
(43) Pub. Date: Mar. 20, 2025

(54) PRINTING DEVICE AND PRINTING METHOD

(71) Applicant: SEIKO EPSON CORPORATION, Tokyo (JP)

(72) Inventor: Tokio NAKAZAWA, Shiojiri (JP)

(21) Appl. No.: 18/884,210

(22) Filed: Sep. 13, 2024

(30) Foreign Application Priority Data
Sep. 15, 2023 (JP) 2023-149898

(51) Int. Cl. G06F 3/12

(52) U.S. Cl. CPC G06F 3/121; G06F 3/1205; G06F 3/1234

(57) ABSTRACT

A printing device includes: an acceptance unit configured to accept a print command and a non-print command as commands belonging to different command groups from each other; a determination unit configured to determine whether there is an association or no association between the print command and the non-print command in the different command groups; a printing unit configured to cause a printing mechanism to perform printing according to the print command; and a cancellation unit configured to cancel the non-print command determined as being associated with the print command, along with the print command, in response to acceptance of a cancellation instruction for the print command.

The present application is based on, and claims priority from JP Application Serial Number 2023-149898, filed Sep. 15, 2023, the disclosure of which is hereby incorporated by reference herein in its entirety.

### BACKGROUND

### 1. Technical Field

The present disclosure relates to a printing device and a printing method.

### 2. Related Art

According to the related art, a label printer can print by methods such as middleware, command direct, and RIP methods other than printing via a driver provided by the manufacturer, and implements printing by using a printer control command (for example, ESC/Label or the like) in these printing methods. JP-A-9-254483 describes that a form overlay printing device creates form data according to a description language.

JP-A-9-254483 is an example of the related art.

Printer control commands include a unit called a format representing a command set. A developer who creates middleware or an application can freely design a command configuration in a format. Therefore, the description of how a plurality of commands causing the printer to perform the same operation belong to the format varies, depending on the type or the like of the middleware or the application. However, the label printer has a format-based cancellation function and therefore has a problem in that the range of commands to be cancelled changes as the format configuration varies.

### SUMMARY

According to an aspect of the present disclosure, a printing device includes: an acceptance unit configured to accept a print command and a non-print command as commands belonging to different command groups from each other; a determination unit configured to determine whether there is an association or no association between the print command and the non-print command in the different command groups; a printing unit configured to cause a printing mechanism to perform printing according to the print command; and a cancellation unit configured to cancel the non-print command determined as being associated with the print command, along with the print command, in response to acceptance of a cancellation instruction for the print command.

According to another aspect of the present disclosure, a printing method includes: accepting a print command and a non-print command as commands belonging to different command groups from each other; determining whether there is an association or no association between the print command and the non-print command in the different command groups; causing a printing mechanism to perform printing according to the print command; and cancelling the non-print command determined as being associated with the print command, along with the print command, in response to acceptance of a cancellation instruction for the print command.

### BRIEF DESCRIPTION OF THE DRAWINGS

FIG. 1 is a block diagram of a printing device.

FIG. 2 shows an example of a command transmitted from a host device.

FIG. 3 shows an example of an association setting screen.

FIG. 4 is a flowchart of setting processing.

FIG. 5 is a flowchart of automatic association processing.

FIG. 6 shows an example of reconfiguration of commands.

FIG. 7 shows an example of reconfiguration of commands.

FIG. 8 is a flowchart of cancellation processing.

FIG. 9 is a flowchart of manual association processing.

FIG. 10 is a flowchart of manual association sub-processing.

FIG. 11 shows an example of reconfiguration of commands.

FIG. 12 shows an example of reconfiguration of commands.

FIG. 13 shows an example of a cancellation target guide screen.

### DESCRIPTION OF EMBODIMENTS

An embodiment of the present disclosure will now be described in the following order.
(1) Configuration of Printing Device
(2) Association Setting
(3) Execution and Cancellation of Command
(4) Other Embodiments

### (1) Configuration of Printing Device

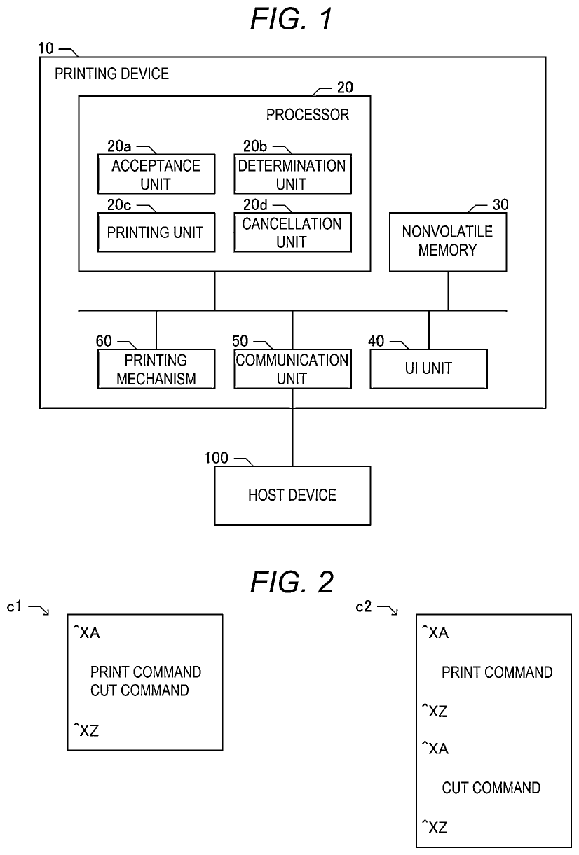

FIG. 1 is a block diagram showing the configuration of a printing device 10 according to an embodiment of the present disclosure. The printing device 10 according to this embodiment is a label printer that prints on a label. The printing device 10 has a processor 20, a nonvolatile memory 30, a UI unit 40, a communication unit 50, and a printing mechanism 60. The processor 20 has a CPU, a ROM, a RAM and the like, not illustrated, and can execute various programs recorded in the nonvolatile memory 30 and control each part of the printing device 10. The processor 20 may be configured with a single chip or may be configured with a plurality of chips. Also, for example, an ASIC may be employed instead of the CPU, or a configuration where the CPU and the ASIC collaborate with each other may be employed.

The communication unit 50 includes a communication interface to communicate with an external device in conformity with various wired or wireless communication protocols. The communication unit 50 includes an interface to communicate with various removable memories attached to the printing device 10. The printing device 10 can communicate with a host device 100 via the communication unit 50. The host device 100 is a terminal that can give a print instruction to the printing device 10 and configure various settings for the printing device 10, and is, for example, a PC, a tablet, or the like.

The printing mechanism 60 prints a content on a print medium under the control of the processor 20. In this embodiment, it is assumed that the printing device 10 is a label printer, that the printing system in the printing mechanism 60 is an inkjet system, and that the recording medium is a rolled paper. The printing mechanism 60 has an actuator, various devices, a sensor, a drive circuit, a mechanical part or the like to execute printing on the print medium. The printing mechanism 60 may be configured to be able to implement various functions for printing. For example, in this embodiment, the printing mechanism 60 includes a cutting mechanism to cut the rolled paper, and a feeding mechanism to feed the rolled paper.

The UI unit 40 includes a touch panel display, various keys, switches, a buzzer, and the like. The touch panel display includes a display panel that displays various kinds of information under the control of the processor 20, and a touch detection panel superimposed on the display panel, and detects a touch operation by a human finger or the like. The processor 20 can also display various information on the display of the UI unit 40 and thus notify the user of the information. The keys provided in the UI unit 40 include a cancel button for the user to input a cancellation instruction. The processor 20 can also acquire the content of an operation by the user via the UI unit 40. The buzzer goes off at a proper timing under the control of the processor 20.

In the nonvolatile memory 30, a print control program, described later, and association setting information representing the setting content of association settings by the user, are recorded. The processor 20 reconfigures the association of commands with reference to the association setting information. Details thereof will be described later.

The processor 20 can execute the print control program, not illustrated, that is recorded in the nonvolatile memory 30. When the processor 20 executing the print control program receives various commands to control the printing device 10 from the host device 100, the processor 20 analyzes the commands and executes the processing indicated by the commands.

The commands include operation commands causing a mechanism provided in the printing device 10 to operate, and non-operation commands that are not commands causing a mechanism to operate. The operation commands include a command to perform printing on the print medium (hereinafter referred to as a print command), and other commands (hereinafter referred to as non-print commands). The non-print commands include, for example, a cut command to cut the print medium, a feed command to feed the print medium, a buzzer command to cause the buzzer to go off, and the like. The non-operation commands include, for example, a setting change command to change various settings of the printing device 10, a status acquisition command to acquire the status of the printing device 10, and the like. Of these commands, commands that can be targets to be cancelled by the cancel button are the operation commands. Since the operation commands can be cancelled, the amount of rolled paper and ink that is unnecessarily consumed due to print failure can be suppressed and the buzzer can be prevented from going off at an unwanted timing. In this embodiment, the non-operation commands are not targets to be cancelled by the cancel button.

FIG. 2 shows an example of a command transmitted from the host device 100 to the printing device 10. The command is transmitted from the host device 100 in the form of belonging to one command group (called “format”). One or more commands included in one command group are enclosed by a start character string and an end character string that indicate the range of this command group. In this embodiment, the start character string is, for example, “\hat{ }XA”, and the end character string is, for example, “\hat{ }XZ”. Therefore, the printing device 10 side can specify the range of the command group, based on the start character string and the end character string.

A plurality of commands may belong to command groups or may belong to the same command group, depending on the type of the application or the middleware for label printing executed by the host device 100. For example, a print command and a cut command may belong to the same command group as indicated by c1 in FIG. 2, or a print command and a cut command may belong to different command groups from each other as indicated by c2 in FIG. 2. No matter how a plurality of operation commands belong to a command group or command groups, when the same operation commands are arranged in the same order, the printing device 10 similarly executes the operations indicated by the operation commands. For example, even when the command set c1 in FIG. 2 is accepted or the command set c2 is accepted, the printing device 10 similarly performs cutting according to the cut command after performing printing according to the print command.

The printing device 10 has a function of cancelling all of the commands that are already accepted by the printing device 10 but the execution of which is not complete (called “all-format cancellation”), and a function of being able to give a cancellation instruction for the operation commands on a per command group basis (called “head-format cancellation”). When a cancellation instruction on a per command group basis is given (head-format cancellation is performed), the range of commands to be cancelled by one cancellation instruction differs if the configuration of the command group differs. For example, in the case of the command set c1 in FIG. 2, the print command and the non-print command (in this example, the cut command) are cancelled by one cancellation instruction, and in the case of the command set c2 in FIG. 2, only the print command is cancelled by one cancellation instruction. Therefore, in the case of the command set c2, only cutting is performed even when printing is cancelled.

However, there may be a case where the user is not aware of or does not grasp how a command set which the user gives an instruction to execute via the application or the like of the host device 100 is included and configured in a command group in the application or the middleware or the like of the host device 100. In such a case, the result of a cancellation instruction given by the user to the printing device 10 during the execution of the processing of the command may be not as intended. To cope with this, the processor 20 implements a function of reconfiguring the association between commands on the printing device 10 side so that, when the user not grasping how the command group is configured gives a cancellation instruction, the result of cancellation as intended can be acquired. The print control program is a program to cause the processor 20 to implement this function.

### (2) Association Setting

In this embodiment, an opportunity for the user to be able to configure a setting about the association between commands in order to reconfigure the association between commands is provided. This setting is to enable the setting of a range intended by the user as a cancellation range when a cancellation instruction is given, and can be configured at a timing when the user wants to change the content of the setting.

Specifically, the processor 20 causes the user to select whether to configure the setting of the association between commands automatically or manually. When manual setting is employed, the processor 20 also causes the user to set, for each operation command, whether to associate the operation command with the immediately previous operation command, whether to associate the operation command with the immediately subsequent operation command, or whether to not associate the operation command with either one of the immediately previous and subsequent operation commands.

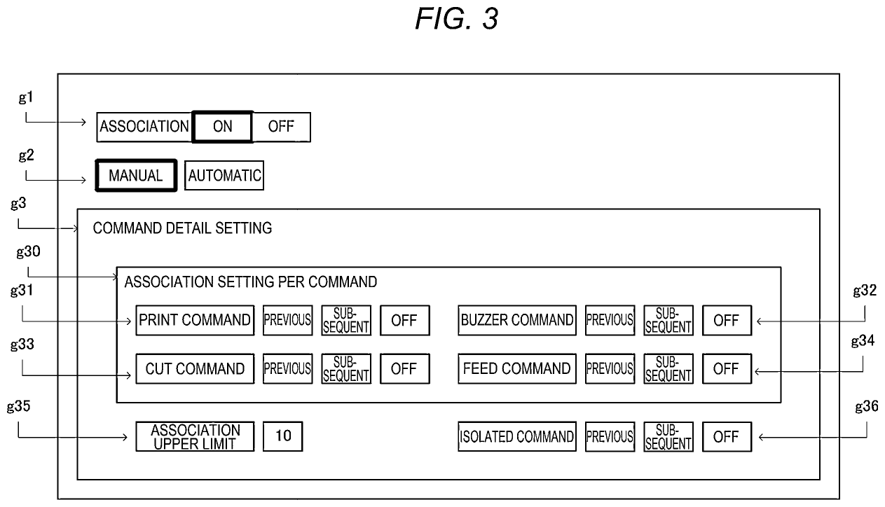

FIG. 3 shows an example of an association setting screen. The user can operate the host device 100 to display the association setting screen of the printing device 10 on the display of the host device 100 and thus can configure an association setting from the host device 100. The content of the setting configured by the user via the association setting screen shown in FIG. 3 is transmitted to the printing device 10. The association setting screen shown in FIG. 3 may be displayed at the UI unit 40 of the printing device 10 and may be configured in such a way that the user configures an association setting via the screen shown in FIG. 3 displayed at the UI unit 40 of the printing device 10.

The association setting screen shown in FIG. 3 includes an association/no-association selection unit g1 to select ON/OFF of association. When OFF is selected at the association/no-association selection unit g1, an association between commands is not made and the command group in the form configured by the application or the middleware of the host device 100 is enabled as it is, and when the user gives a cancellation instruction for “head-format cancellation” to the printing device 10, commands included in the command group including the command that is currently being executed are cancellation targets. The association setting screen includes a manual/automatic selection unit g2 to select manual association or automatic association. When ON is selected at the association/no-association selection unit g1, the selection of manual or automatic is enabled at the manual/automatic selection unit g2. When automatic is selected at the manual/automatic selection unit g2, a command detail setting unit g3 is disabled.

In this embodiment, when “automatic” is selected at the manual/automatic selection unit g2 and one or more non-print commands come consecutively after a print command, an association between the print command and the one or more consecutive non-print commands is made (automatic association rule). An association between consecutive print commands or an association with a print command subsequent to a non-print command is not made. Based on a design concept that, in many cases, an operation according to a non-print command is combined with a print operation according to an immediately prior print command, such an automatic association rule is employed for the automatic setting in this embodiment.

The user can cancel all the commands stored in the printing device 10 by designating “all-format cancellation”, and can cancel commands based on the automatic association rule as described above (to associate a print command and one or more non-print commands subsequent thereto) by designating “head-format cancellation” in the state where “automatic” is selected on the association setting screen shown in FIG. 3. When “head-format cancellation” is designated in the state where “manual” is selected on the association setting screen shown in FIG. 3, the command detail setting unit g3 is presented so that a cancellation range according to more detailed intentions of the user can be implemented.

When manual is selected at the manual/automatic selection unit g2, the command detail setting unit g3 is enabled for the user to configure a setting. The command detail setting unit g3 includes an association setting unit per command g30, an association upper limit setting unit g35, and an isolated command setting unit g36. The association setting unit per command g30 is a setting unit to set, for each command, whether to associate the command with the immediately previous command (previous), whether to associate the command with the immediately subsequent command (subsequent), or whether to not associate the command with any other command (OFF). “Previous”, “Subsequent”, and “OFF” are presented to be selectable in such a way that one of these is selected. In the example shown in FIG. 3, the association setting unit per command g30 includes a print command setting unit g31, a buzzer command setting unit g32, a cut command setting unit g33, and a feed command setting unit g34. The buzzer command is a command to cause the buzzer to go off, the cut command is a command to cut the print medium, and the feed command is a command to feed the print medium. The buzzer command, the cut command, and the feed command are equivalent to non-print commands.

The association upper limit setting unit g35 is a setting unit to set an upper limit of the number of commands to be associated. For example, when “10” is set, the maximum number of operation commands to be associated can be made 10, except for an association with an isolated command, described later, no matter what order a print command and non-print commands are arranged in. When the user does not want to cancel all the commands at a time as in “all-format cancellation” but allows the cancellation of a certain number of commands at a time, the user can control the cancellation as intended, by the number set at the association upper limit setting unit g35.

The isolated command setting unit g36 is a setting unit configured for a case where only one command is not associated with any other command and becomes an isolated command when an association is made based on the content of the setting at the association setting unit per command g30 and the content of the setting at the association upper limit setting unit g35, and is configured to select whether to associate the isolated command with the command “previous” to the isolated command or the command “subsequent” to the isolated command” or to leave the isolated command isolated.

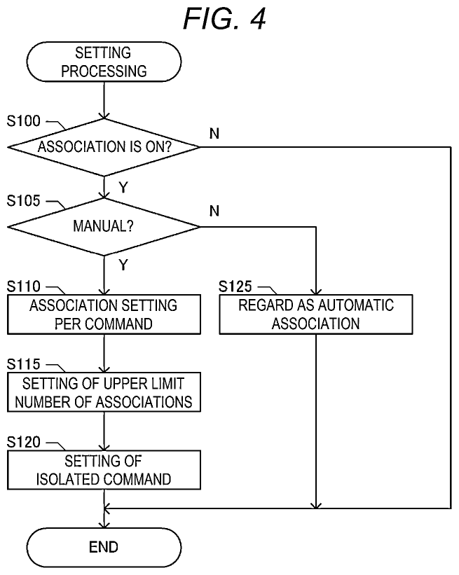

FIG. 4 shows setting processing executed to acquire a content of setting set on the association setting screen shown in FIG. 3 when the content of the setting is transmitted to the printing device 10. First, the processor 20 determines whether ON is selected at the association/no-association selection unit g1 (step S100), and when ON is selected, the processor 20 determines whether manual is selected at the manual/automatic selection unit g2 (step S105). When manual is selected, the processor 20, when accepting a command, reconfigures the association, based on the content designated by the user (reconfiguration mode: manual) and acquires the content of the setting at the association setting unit per command g30, the content of the setting at the association upper limit setting unit g35, and the content of the setting at the isolated command setting unit g36 (steps S110, S115, S120) When it is determined in step S105 that automatic is selected, the processor 20 assumes automatic association (step S125). That is, when accepting a command, the processor 20 reconfigures the association according to the above-described automatic association rule (reconfiguration mode: automatic). When OFF is selected in step S100, the processor 20 does not reconfigure the association at the printing device 10 when accepting a command, and when a cancellation instruction is given, the processor 20 executes cancellation based on the configuration of the command group of the accepted command set (reconfiguration mode: OFF).

### (3) Execution and Cancellation of Command

When a command set is transmitted from the host device 100, the processor 20 executes the print control program, analyzes the commands, reconfigures the association between the commands according to the state of the reconfiguration mode, and controls each part of the printing device 10 to execute processing according to the commands. When accepting a cancellation instruction, the processor 20 performs cancellation according to the state of the reconfiguration mode.

When the print control program is executed, the processor 20 functions as an acceptance unit 20a, a determination unit 20b, a printing unit 20c, and a cancellation unit 20d. With the function of the acceptance unit 20a, the processor 20 accepts a command transmitted from the host device 100. As described above, commands include operation commands and non-operation commands, and the operation commands include a print command and a non-print command. Also, a print command and a non-print command may be transmitted from the host device 100 as command belonging to the same command group or may be transmitted as commands belonging to different command groups. Therefore, when a print command and a non-print command are configured to belong to different command groups from each other and transmitted from the host device 100, the processor 20 accepts the print command and the non-print command as commands belonging to different command groups from each other.

With the function of the determination unit 20b, the processor 20 determines whether there is an association or no association between accepted commands. For example, when accepting a print command and a non-print command as commands belonging to different command groups, the processor 20 determines whether there is an association or no association between the print command and the non-print command in the different command groups. Specifically, when the reconfiguration mode is manual, the processor 20 reconfigures the association between the commands according to the association setting unit per command g30 (see FIG. 3), and when the reconfiguration mode is automatic, the processor 20 reconfigures the association between the commands according to the automatic association rule. When the reconfiguration mode is OFF, the processor 20 does not reconfigure the association between the commands.

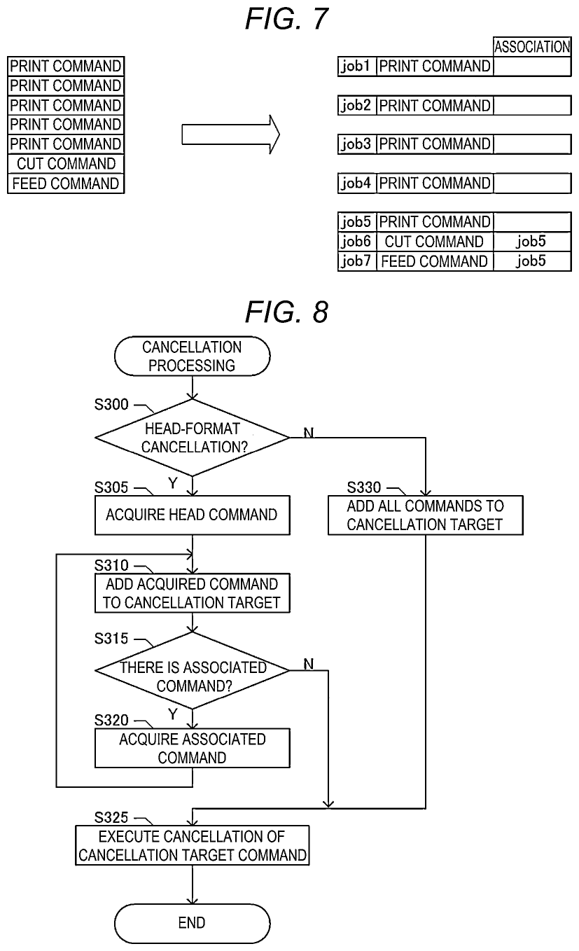

When the reconfiguration mode is automatic or manual, the processor 20 regards operation commands consecutive in the order of execution of commands, as commands to be associated. Therefore, for example, when a command A, a command B, and a command C, which are operation commands, are consecutive, the command A and the command B, or the command B and the command C, are subject to association determination. When the reconfiguration mode is automatic, the processor 20 determines that one or more consecutive non-print commands after a print command are to be associated (see FIGS. 6 and 7). That is, the processor 20 associates the print command with the one or more consecutive non-print commands after the print command. As these commands are associated in this way, the one or more consecutive non-print command immediately after the print command can be cancelled together in response to a cancellation instruction for the print command. When the reconfiguration mode is manual (later described in detail), too, the print command and the subsequent non-print command may be associated with each other, depending on the content of the setting at the association setting unit per command g30.

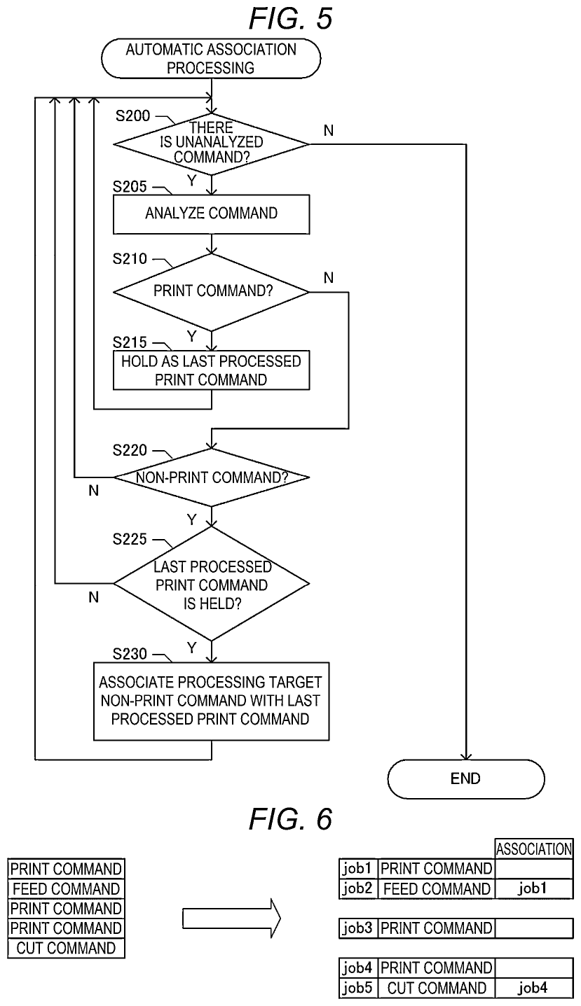

The automatic association processing shown in FIG. 5 is the processing executed by the processor 20 when accepting a command set in the state where the reconfiguration mode is automatic. Before the execution of the automatic association processing, variables to be used in the automatic association processing are initialized (for example, the last processed print command=NULL, or the like). As the automatic association processing is started, the processor 20 determines whether there is an unanalyzed command (step S200) and repeats processing of steps S205 to S230 for each command from the head in the order of execution until there is no longer any unanalyzed command (that is, until all the commands are already analyzed). The earliest command in the order of execution whose analysis is not complete is called a processing target command. In step S205, the processor 20 analyzes the command. That is, the processing target command is specified. Subsequently, the processor 20 determines whether the processing target command is a print command (step S210), and when the processing target command is a print command, the processor 20 holds the processing target print command as the last processed print command (step S215) and returns to step S200. Every time step S215 is executed, the last processed print command is updated with the processing target print command.

When it is determined in step S210 that the processing target command is not a print command, the processor 20 determines whether the processing target command is a non-print command (step S220). When it is not determined in step S220 that the processing target command is a non-print command (that is, when the processing target command is a non-operation command), the processor 20 returns to the processing of step S200. When it is determined in step S220 that the processing target command is a non-print command, the processor 20 determines whether the last processed print command is held (step S225). When it is determined in step S225 that the last processed print command is held, the processor 20 associates the processing target non-print command with the last processed print command (step S230) and returns to step S200. When it is determined in step S225 that the last processed print command is not held, the processor 20 does not associate the processing target non-print command with any one of the previous and subsequent commands and returns to step S200.

In this embodiment, the processor 20 generates a job corresponding to each command and saves the job until the execution thereof is completed. For commands determined as being associated with each other, the job data is saved in the state where a designation indicating that one job is associated with the other job is described. In this embodiment, the processor 20 can recognize the association relationship between commands (reconfigured command group) by referring to whether this designation is given and the content thereof, in the job data corresponding to each command.

FIGS. 6 and 7 show an example of reconfiguration when the automatic association processing shown in FIG. 5 is executed. FIG. 6 shows an example of reconfiguration of a command set in an order of execution of a print command, a feed command, a print command, a print command, and a cut command. No matter what command group configuration the command set transmitted from the host device 100 has, an association determination is made for each command when reconfiguration is performed at the printing device 10, and therefore the command group when the command set is accepted is not illustrated in FIG. 6. As shown in FIG. 6, based on the automatic association rule, when a non-print command comes after a print command, the print command and the non-print command are associated with each other. In the job data corresponding to the associated non-print command, the designation of the job of the associated target is described.

Also, for example, FIG. 7 shows an example of reconfiguration when a cut command and a feed command come after five print commands come consecutively. As shown in FIG. 7, based on the automatic association rule, the print commands that are the first to fourth in order are not associated with each other, and the print command which is the fifth in order is associated with the two consecutive non-print commands after that (the cut command, which is the sixth in order, and the feed command, which is the seventh in order). In the job data corresponding to the associated non-print command, the designation of the job of the associated target is described.

When the reconfiguration mode is automatic, the association is reconfigured in this way and then the commands are executed. That is, with the function of the printing unit 20c, the processor 20 causes the printing mechanism to perform printing according to the print command. In this embodiment, the processor 20 causes the printing to be performed on a rolled paper. The processor 20 also causes the operation indicated by the non-print command to be executed, according to the non-print command (for example, feed, cut, buzzer or the like).

A case where a cancellation instruction is inputted to the printing device 10 in the state where the association between commands is reconfigured will now be described. With the function of the cancellation unit 20d, in response to the acceptance of a cancellation instruction for a print command, the processor 20 cancels a non-print command determined as being associated with the print command, along with the print command.

Specifically, when cancel button is pressed, the processor 20 temporarily stops the operation of the command that is currently being executed, and suggests the user to select one of the head-format cancellation and the all-format cancellation. The head-format cancellation is to cancel all the commands belonging to the command group to which the head command in the execute order belongs, of the operation commands (whose execution is not complete) stored in the printing device 10 (the commands in the group subsequent to this command group are not cancelled). The all-format cancellation is to cancel all the operation commands (whose execution is not complete) stored in the printing device 10. In this embodiment, when the head-format cancellation is selected and the reconfiguration mode is automatic or manual, the range of commands to be cancelled is determined, based on the reconfigured association. When the reconfiguration mode is OFF, the range of cancellation is determined, using the configuration of the command group accepted from the host device 100, as it is.

A specific example will now be described with reference to the cancellation processing shown in FIG. 8. The cancellation processing shown in FIG. 8 is executed, when the cancel button of the printing device 10 is pressed and the user selects one of the head-format cancellation and the all-format cancellation. When the cancellation processing is started, the processor 20 determines whether the head-format cancellation is selected (step S300). When it is determined in step S300 that the head-format cancellation is selected, the processor 20 acquires the head command (step S305). Subsequently, the processor 20 adds the acquired command to the cancellation targets (step S310).

Subsequently, the processor 20 determines whether there is a command associated with the acquired command (step S315). That is, the processor 20 determines whether there is another command associated with the acquired command or whether the acquired command is associated with another command, referring to the designation of the association in the job data corresponding to the acquired command.

When it is determined in step S315 that there is an associated command, the processor 20 acquires the associated command (step S320). That is, the processor 20 acquires all the commands belonging to the same group as the acquired command in the relationship of the reconfigured association, based on the designation of the association in the job data. After the execution of step S320, the processor 20 returns to step S310. When it is not determined in step S315 that there is an associated command, the processor 20 executes the cancellation of the cancellation target commands (step S325). That is, the execution of the job corresponding to each of the cancellation target commands is cancelled.

When it is not determined in step S300 that the head-format cancellation is selected, the processor 20 determines that the all-format cancellation is selected, and therefore adds all the commands to the cancellation targets (step S330) and executes step S325.

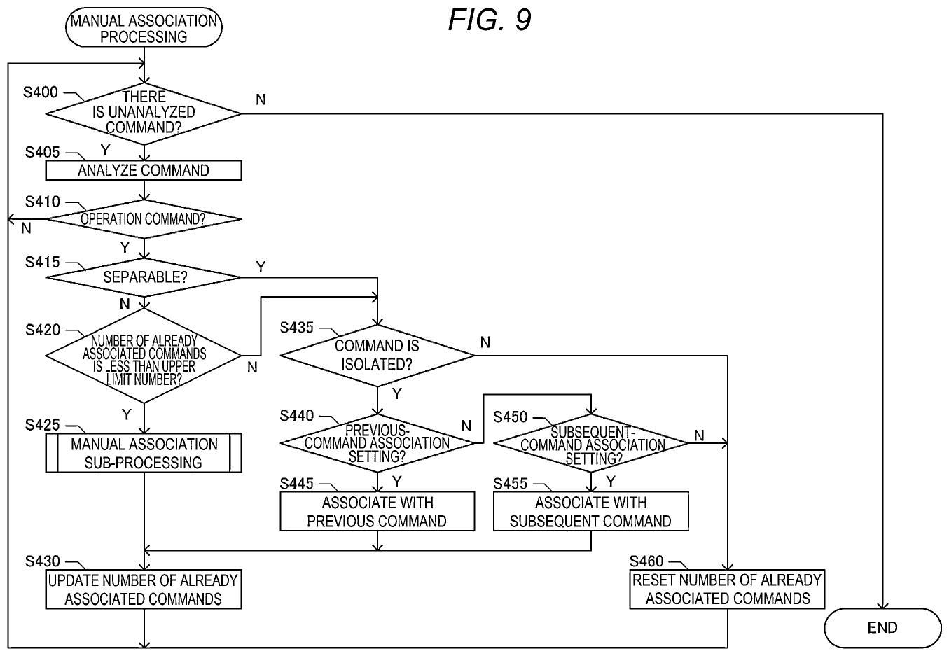

The association processing when the reconfiguration mode is manual will now be described. FIG. 9 is a flowchart of manual association processing. The manual association processing is the processing executed by the processor 20 when accepting a command set in the state where the reconfiguration mode is manual. Before the execution of the manual association processing, variables to be used in the manual association processing are initialized (for example, the number of already associated commands=0, the immediately previous command (the command immediately previous to the processing target command)=NULL, or the like). As the manual association processing is started, the processor 20 determines whether there is an unanalyzed command (step S400) and performs processing from step S405 onward, taking each command in the order of execution of unanalyzed commands, as a processing target.

When it is determined in step S400 that there is an unanalyzed command, the processor 20 analyzes the processing target command (step S405). That is, the processing target command is specified.

Subsequently, the processor 20 determines whether the processing target command is an operation command (step S410). That is, whether the processing target command is an operation command given at the association setting unit per command g30 on the association setting screen shown in FIG. 3 is determined. When it is not determined in step S410 that the processing target command is an operation command, the processor 20 returns to step S400.

When it is determined in step S410 that the processing target command is an operation command, the processor 20 determines whether the processing target command can be separated (step S415). That is, the processor 20 determines whether the processing target command and the command immediately previous to the processing target command in the order of execution are in a relationship of no association. For example, when the immediately previous command is set to be associated with the “previous” command and the processing target command is set to be associated with the “subsequent” command, the processor 20 determines that the immediately previous command and the processing target command can be separated into different command groups.

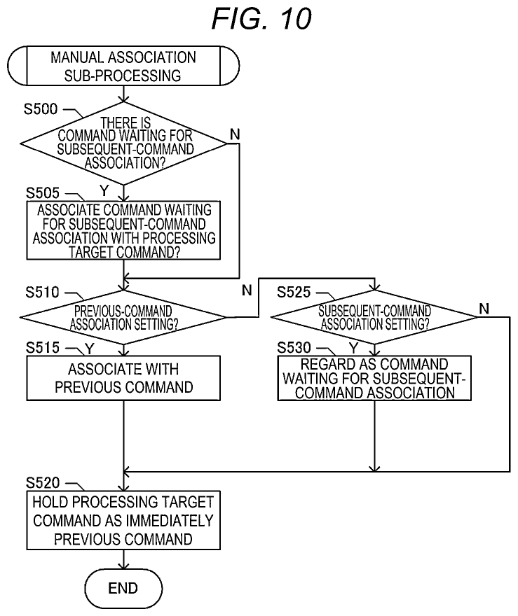

When it is not determined in step S415 that the processing target command can be separated, the processor 20 determines whether the number of already associated commands is less than an upper limit number (step S420). That is, whether the number of already associated commands is less than the upper limit number that is set at the association upper limit setting unit g35 in FIG. 3 is determined. When it is determined in step S420 that the number of already associated commands is less than the upper limit number, the processor 20 performs manual association sub-processing shown in FIG. 10 (step S425).

In the processing of step S500, the processor 20 determines whether there is a command waiting for subsequent-command association (step S500). That is, when the processing target is an n-th command, n being an integer equal to or greater than 2, whether the association setting of the (n−1)th command is “subsequent” is determined. When the head command in a series of commands accepted by the printing device 10 is the processing target (that is, when n=1), there is no command waiting for subsequent-command association and therefore the result of the determination in step S500 is N.

When the result of the determination in step S500 is N, that is, when it is not determined that there is a command waiting for subsequent-command association, the processor 20 determines whether the association setting of the processing target command is “previous” (step S510). When it is determined in step S510 that the association setting of the processing target command is “previous”, the processor 20 associates the processing target command with the previous command (step S515). That is, when there is a command held as the immediately previous command, the processor 20 associates this held command with the processing target command (when there is no command held, no association is made).

Subsequently, the processor 20 holds the current processing target command as the immediately previous command (step S520). The command thus held is referred to when step S515 is executed next time.

When it is not determined in step S510 that the association setting of the processing target command is “previous”, the processor 20 determines whether the association setting of the processing target command is “subsequent” (step S525). When it is determined in step S525 that the association setting of the processing target command is “subsequent”, the processor 20 regards the processing target command as a command waiting for subsequent-command association (step S530) and executes step S520. When step S530 is executed, the result of the determination in step S500 is Y when executed next time. When step S530 is not executed for the processing target command, it is indicated that this command is not in the state of waiting for subsequent-command association.

When it is not determined in step S525 that the association setting of the processing target command is “subsequent”, that is, when the association setting of the processing target command is “OFF”, the processor 20 proceeds to the processing of step S520.

When it is determined in step S500 that there is a command waiting for subsequent-command association, the processor 20 associates the command waiting for subsequent-command association with the processing target command (step S505). That is, the command held in the previous step S520 and the processing target command are associated with each other. After the execution of step S505, the processing is performed from the above step S510 onward. There may be a case where both steps S505 and S515 are executed in the manual association sub-processing of this time, and in steps S505 and S515 in this case, the same commands (the command immediately previous to the processing target command and the processing target command) are associated with each other.

Referring back to FIG. 9, the description continues. After step S425 is executed, the processor 20 updates the number of already associated commands (step S430). That is, the number of already associated commands is updated with the total number of commands associated as a result of the processing of step S425, and steps S445 and S455, described later (the total number, as of that time, of commands belonging to the target group that is being reconfigured).

When it is determined in step S415 that the processing target command can be separated, or when it is not determined in step S420 that the number of already associated commands is less than the upper limit number, the processor 20 determines whether the command is isolated (step S435). Step S435 is executed when the processing target command is determined as not being associated with the immediately previous command, and in step S435, the processor 20 determines whether the processing target command is isolated, referring to the association setting of the command subsequent to the processing target command. The term “isolated” refers to the state where a command is not associated with either the immediately previous command or the immediately subsequent command and stands alone. For example, it is now assumed that the command immediately previous to the processing target command is a command A, that the processing target command is a command B, and that the command immediately subsequent to the processing target command is a command C. When the association setting of the command A is “previous”, the association setting of the command B is “previous”, the association setting of the command C is “subsequent”, and the number of already associated commands reaches the upper limit with the command A, it is determined that the command B is isolated. Also, for example, when commands with the association setting of “OFF” come consecutively, the command B may be isolated.

When it is determined in step S435 that the command is isolated, the processor 20 determines whether the association setting of the isolated command is “previous” (step S440). That is, the content set at the isolated command setting unit g36 in FIG. 3 is referred to. When it is determined in step S440 that the association setting is “previous”, the processor 20 associates the processing target command with the command immediately previous to the processing target command (step S445). As the processing target command is associated with the immediately previous command, the upper limit number of associated commands may be exceeded, but in this embodiment, the content of the setting at the isolated command setting unit g36 is given priority and the association is made even when the upper limit number is exceeded.

When it is not determined in step S440 that the association setting is “previous”, the processor 20 determines whether the association setting of the isolated command is “subsequent” (step S450). When it is determined in step S450 that the association setting is “subsequent”, the processor 20 associates the processing target command with the subsequent command (step S455). That is, the processing target command determined as being isolated is associated with the command subsequent to the processing target command so that the processing target command is not isolated. For example, when it is assumed that the processing target command is a command B and that the command subsequent to the processing target command is a command C, the command B and the command C are associated with each other in step S455.

When it is not determined in step S435 that the command is isolated, the processor 20 resets the number of already associated commands (step S460). When step S460 is executed, the association is separated at the processing target command as the terminal end and therefore the processor 20 resets the number of already associated commands to 0.

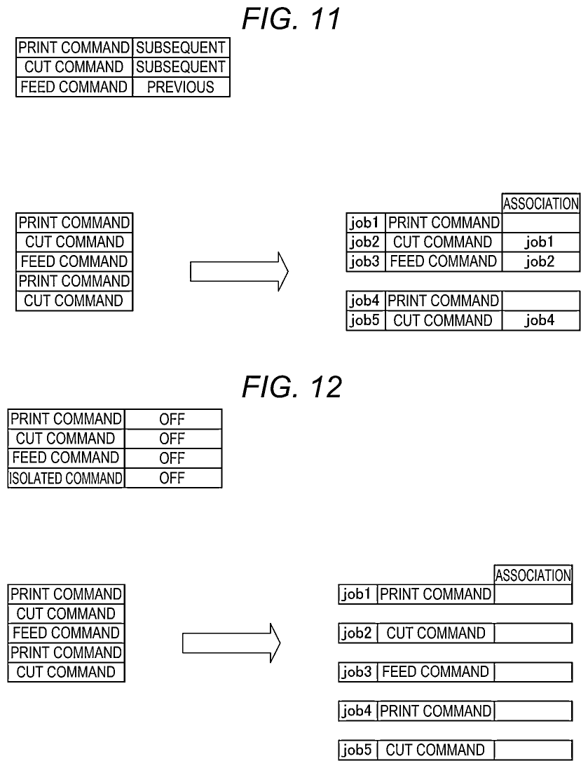

An example of reconfiguration of commands by the foregoing manual association processing will be described with reference to FIGS. 11 and 12. A case where the association settings of a print command, a cut command, and a feed command are “subsequent”, “subsequent”, and “previous”, respectively, and where a print command, a cut command, a feed command, a print command, and a cut command are accepted in this order of execution, as shown in FIG. 11, is assumed. Since the association setting of the print command at the head is “subsequent”, this command is associated with the cut command that is the second in order. Since the association setting of the cut command that is the second in order is “subsequent”, too, this command is further associated with the feed command that is the third in order. Since the association setting of the feed command is “previous”, this command is associated with the cut command that is the second in order, which is the immediately previous command. Since the association setting of the feed command is “previous” and the association setting of the print command that is the fourth in order is “subsequent”, the association is separated between the feed command that is the third in order and the print command that is the fourth in order. Since the print command that is the fourth in order and the cut command that is the fifth in order are similarly associated with each other and the print command that is the fourth in order is not isolated, the first group includes a print job as a job 1, a cut job as a job 2, and a feed job as a job 3, and the second group includes a print job as a job 4 and a cut job as a job 5. In this way, even with a non-print command immediately previous to a print command, the processor 20 may determine that the two commands are not associated with each other, depending on the content that is preset by the user (the content of the association settings of the two commands, the upper limit number of associated commands, and the content of association setting in the case of isolation). Therefore, the association between even consecutive commands can be avoided, depending on the content of the manual setting by the user. It is described in the job data of the job 2 that the job 2 is associated with the job 1, and it is described in the job data of the job 3 that the job 3 is associated with the job 2, whereas it is described in the job data of the job 5 that the job 5 is associated with the job 4.

As shown in FIG. 12, when all the association settings of a print command, a cut command, and a feed command are “OFF” and the association setting of an isolated command is “OFF”, too, the processor 20 does not associate the print command, the cut command, and the feed command. In this way, even with a non-print command immediately subsequent to a print command, the processor 20 may determine that these commands are not associated with each other, based on the foregoing content of the association setting that is preset by the user. Therefore, the association can be avoided even between consecutive commands, depending on the content of the manual setting by the user.

When a cancellation instruction for the print command that is the first in order is accepted in the reconfigured state as shown in FIG. 12, the processor 20 determines that this print command is not associated with any command. The processor 20 performs the cancellation processing shown in FIG. 8 in response to one cancellation instruction and cancels this one print command. That is, in this embodiment, the processor 20 can delete one command in response to one cancellation instruction, based on the content of the manual setting by the user.

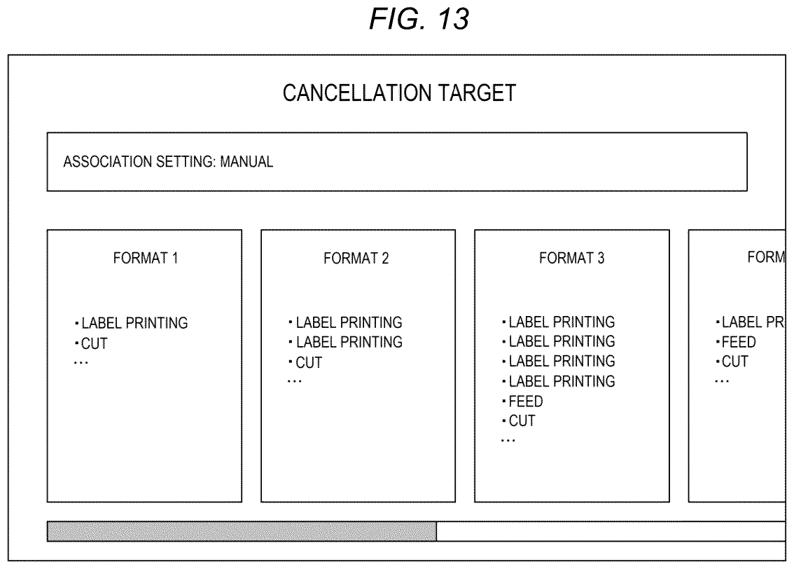

FIG. 13 shows an example of a cancellation target guide screen displayed at the UI unit 40 of the printing device 10, when the cancel button is pressed and the “head-format cancellation” is selected. The cancellation target guide screen presents a group of commands to be cancelled in response to one cancellation instruction, of commands which are already accepted by the printing device 10 and whose execution is not complete. In the example shown in FIG. 13, the reconfiguration mode is assumed to be manual and “manual” is displayed as the association setting. In the example shown in FIG. 13, command groups are presented, arranged in the order of execution from the left. The command group displayed at the leftmost part is a group including a command that is currently being executed (a command group whose execution is complete is hidden), and all the commands belonging to this group are presented in a list. Therefore, the user can recognize a command to be cancelled when pressing the cancel button again to input a cancellation instruction. The cancellation target guide screen shown in FIG. 13 is not limited to when the reconfiguration mode is manual, and may also be displayed when the reconfiguration mode is automatic or OFF. The cancellation target guide screen may also be displayed when the “all-format cancellation” is selected.

### (4) Other Embodiments

The foregoing embodiment is an example for embodying the present disclosure, and various other embodiments can be employed. For example, as the printing system, various systems such as an inkjet system, a toner system, and a sublimation system can be employed, and the print medium may be a cut paper or various print media without being limited to a print paper. The printing device can also be applied to a printer for other purposes than printing a label.

While it is assumed in the above embodiment that one host device 100 is provided for the printing device 10, command sets may be transmitted from a plurality of host devices 100 to one printing device 10. In such a case, the association may be reconfigured without distinguishing the host device 100 of the transmission source, or the association may be reconfigured for each host device 100 of the transmission source, or such configurations may be selectable by the user. The association may be reconfigured for each user transmitting a command set and giving an instruction to execute a series of jobs, or the association may be reconfigured without distinguishing the user, or such reconfigurations may be selectable by the user.

Also, the printing device 10 may store the time when a command is received, may reconfigure the association between commands received within a predetermined time period, and may avoid associating with a command received at an interval exceeding the certain time period.

The operation commands to be cancellation targets may include various other commands than the four types described in the above embodiment. What command is associated in what way is not limited to what is described in the above embodiment.

After the cancellation target guide screen shown in FIG. 13 is displayed, the screen may shift to the association setting screen shown in FIG. 3 in response to an operation by the user, and in the state where the jobs of commands are temporarily stopped, the user may be able to re-set the setting content at the association/no-association selection unit g1, the manual or automatic at the manual/automatic selection unit g2, and the content of the setting at the command detail setting unit g3. The processor 20 may be configured to reconfigure the association between commands again, based on the content of the setting after the re-setting.

When a cancellation instruction is accepted during the execution of an operation command that is not a print command (non-print command), the cancellation unit cancels another command determined as being associated with the no-print command, along with the non-print command.

The determination unit may be configured to determine that a print command is associated with a non-print commands that continues from the print command, and determine that the print command is not associated with a print command that is different from the former print command. For example, in the case of the example shown in FIG. 6, it is not determined that the print command of the job 1 and the cut command of the job 5 are associated with each other (because there is another print command between the print command of the job 1 and the non-print command of the job 5). In the case of the example shown in FIG. 7, the print command of the job 5 and the feed command of the job 7 are not continuous in view of the feed command of the job 7 alone, but two non-print commands come consecutively after the print command of the job 5 and therefore these two consecutive non-print commands can be regarded as continuous from the print command of the job 5.

Also, the present disclosure is applicable as a program executed by a computer or as a method. For example, the contents of the above description may be implemented as a printing method including: accepting a print command and a non-print command as commands belonging to different command groups from each other; determining whether there is an association or no association between the print command and the non-print command in the different command groups; causing a printing mechanism to perform printing according to the print command; and cancelling the non-print command determined as being associated with the print command, along with the print command, in response to acceptance of a cancellation instruction for the print command.

The system, the program, and the method as described above may be implemented as a stand-alone device or may be implemented using components provided in a plurality of devices, and include various aspects. Also, suitable changes can be made such as a part being software and a part being hardware. Moreover, the present disclosure may be implemented as a recording medium storing a program that controls the system. Of course, the recording medium storing the program may be a magnetic recording medium or may be a semiconductor memory, and any recording medium to be developed in the future can be similarly employed.

What is claimed is:

1. A printing device comprising:
an acceptance unit configured to accept a print command and a non-print command as commands belonging to different command groups from each other;
a determination unit configured to determine whether there is an association or no association between the print command and the non-print command in the different command groups;
a printing unit configured to cause a printing mechanism to perform printing according to the print command; and
a cancellation unit configured to cancel the non-print command determined as being associated with the print command, along with the print command, in response to acceptance of a cancellation instruction for the print command.

2. The printing device according to claim 1, wherein
the determination unit determines that the non-print command continuous from the print command is associated.

3. The printing device according to claim 2, wherein
the determination unit determines that a command that is preset by a user, of the non-print commands immediately previous to the print command, is not associated.

4. The printing device according to claim 2, wherein
the determination unit determines that a command that is preset by a user, of the non-print commands immediately subsequent to the print command, is not associated.

5. The printing device according to claim 1, wherein
when it is determined that the print command is not associated with any command, the cancellation unit cancels the print command that is one in response to the cancellation instruction that is one.

6. The printing device according to claim 1, wherein
the determination unit generates a job for each of the print command and the non-print command determined as being associated with each other, and describes a designation indicating that one job is associated with the other job.

7. The printing device according to claim 1, wherein
each of the print command and the non-print command included in the different command groups from each other is enclosed by a start character string and an end character string that indicate a range of the command group.

8. The printing device according to claim 1, wherein
the printing unit causes printing to be performed on a rolled paper.

9. A printing method comprising:
accepting a print command and a non-print command as commands belonging to different command groups from each other;
determining whether there is an association or no association between the print command and the non-print command in the different command groups;
causing a printing mechanism to perform printing according to the print command; and
cancelling the non-print command determined as being associated with the print command, along with the print command, in response to acceptance of a cancellation instruction for the print command.
